(19) United States
(12) Patent Application Publication
(10) Pub. No.: US 2012/0088064 A1
(43) Pub. Date: Apr. 12, 2012

(54) Method For Coating A Component With Film Cooling Holes And Component

(76) Inventors: Andrea Bolz, Berlin (DE); Francis-Jurjen Ladru, Berlin (DE); Falk Stadelmaier, Niederrohrdorf (CH)

(21) Appl. No.: 13/143,575

(22) PCT Filed: Nov. 20, 2009
(86) PCT No.: PCT/EP2009/065542

§ 371 Date: Dec. 12, 2011

(30) Foreign Application Priority Data
Jan. 8, 2009 (EP) 09000151.2

(51) Int. Cl. B32B 3/10; B05D 1/32

(52) U.S. Cl. 428/131; 427/282

(57) ABSTRACT

During the complete masking of film cooling holes when coating a component with film cooling holes, problems frequently arise when the cooling gas exits from the film cooling hole. The method is provided which proposes that the masking is only carried out sectionally such that part of the coating is present in the film cooling hole. Thus the flow may still form like a film on the component.

### CROSS REFERENCE TO RELATED APPLICATIONS

This application is the US National Stage of International Application No. PCT/EP2009/065542, filed Nov. 20, 2009 and claims the benefit thereof. The International Application claims the benefits of European Patent Office application No. 09000151.2 EP filed Jan. 8, 2009. All of the applications are incorporated by reference herein in their entirety.

### FIELD OF INVENTION

The invention relates to the partial masking of film-cooling holes and to components thus produced.

### BACKGROUND OF INVENTION

Components which are subject to high thermal stresses, such as turbine blades or vanes, often have film-cooling bores, out of which air or steam which forms a protective film of air or gas on the turbine blade or vane flows. Here, the film-cooling hole has a diffuser, i.e. a flattening region, such that no separation of the air flow also takes place.

Problems arise during the coating of turbine blades or vanes with preexisting film-cooling holes, in the case of which the coating from the prior art leads to problems.

### SUMMARY OF INVENTION

It is therefore an object of the invention to solve this problem. The object is achieved by a method as claimed in the claims and by a component as claimed in the claims.

The dependent claims list further advantageous configurations which can be combined with one another, as desired, in order to obtain further advantages.

### BRIEF DESCRIPTION OF THE DRAWINGS

FIGS. 1, 4, 6-9 are various views showing exemplary embodiments of a film-cooling hole with masking,

FIGS. 2, 3 show examples of diffusers,

FIG. 5 shows a component with a coating in the diffuser,

FIG. 10 shows a gas turbine,

FIG. 11 shows a turbine blade or vane, and

FIG. 12 shows a combustion chamber.

The description and the figures represent only exemplary embodiments of the invention.

### DETAILED DESCRIPTION OF INVENTION

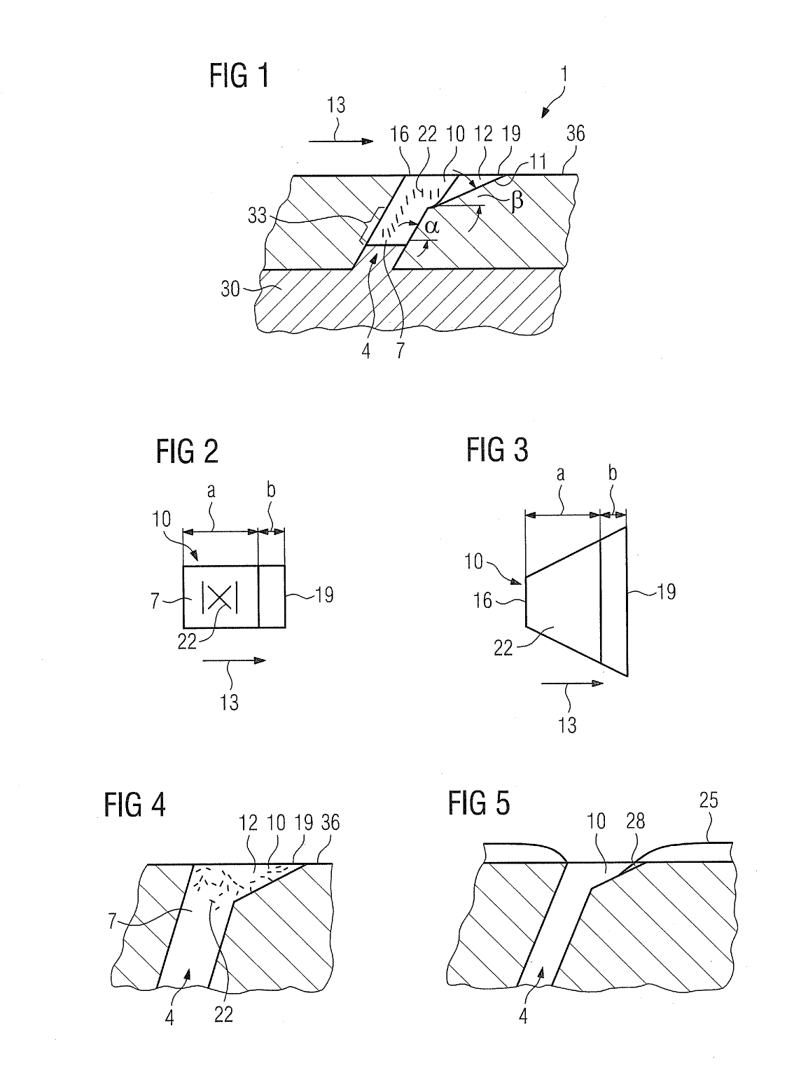

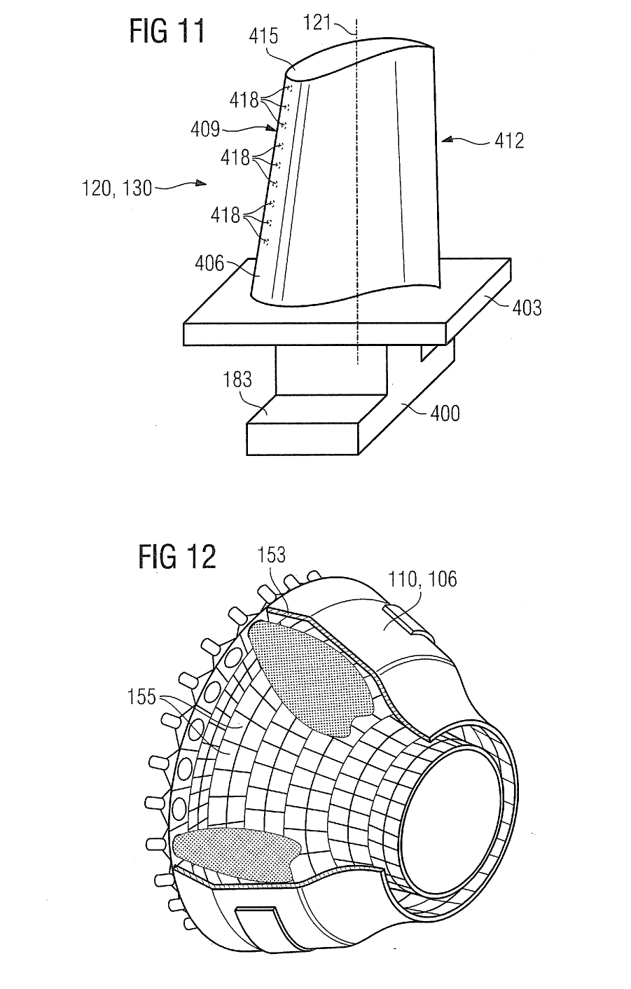

FIG. 1 shows a film-cooling hole 4 of a substrate of a component 1, 120, 130 (FIG. 11), 155 (FIG. 12).

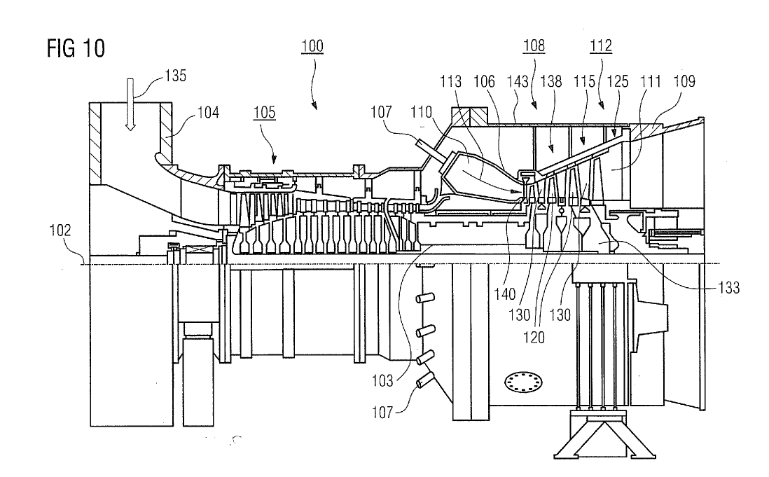

The component 1 is preferably a turbine blade or vane 120, 130 of a gas turbine 100 (FIG. 10).

The film-cooling hole 4 has an inner, preferably cylindrical portion 7. The inner portion 7 begins in the cavity 30 and extends as far as the diffuser 10 (4=7+10). The inner portion 7 preferably has a constant cross section.

The film-cooling hole 4 also has an outer diffuser 10, which deviates from the geometry of the inner region 7, i.e. the cross section thereof increases toward the outer surface 36. The diffuser 10 is also characterized in particular by a widening of the cross-sectional opening transversely to a direction of flow 13 of a hot gas, which flows past the component 1 (FIG. 3). The diffuser 10 represents the entire outward delimitation of the film-cooling hole 4.

Therefore, as seen in the direction of flow 13 (parallel to the surface 36 of the substrate), the diffuser 10 has an end 19, the region of which extends in a more shallow manner with respect to the surface 36 than in the cylindrical portion 7 of the film-cooling hole 4, i.e. the angle of inclination β in the diffuser 10 with respect to the surface 36 is smaller than the angle α in the cylindrical portion 7.

There is preferably only an inclination a in the cylindrical portion 7 and preferably only an inclination β in the diffuser 10. In particular, there is no further step in the region with the inclination β. The inner surface 11 of the diffuser 10 extends rectilinearly, that is to say has no step or depression.

If a component 1, 120, 130, 155 is to be coated, a masking material 22, in particular a polymer, is introduced into the film-cooling hole 4 and thus into the diffuser 10. The polymer may contain ceramics or reinforcing particles and/or be cured (by UV) before the coating.

The polymer is preferably introduced only partially into the film-cooling hole 4. Here, an upper part 33 of the inner portion 7 of the film-cooling hole 4 is preferably filled completely with the polymer, whereas the diffuser 10 is filled only partially. There is therefore preferably no masking material 22 (polymer) at the end 19 of the diffuser 10. Where it is introduced, however, the masking material 22 preferably passes at least as far as the height of the outer surface 36 of the substrate 30 (FIG. 1).

The majority of the polymer (masking material 22) is arranged in the film-cooling hole 4, and there is less or preferably no polymer at all in the inner cavity 30 of the component 1, 120, 130, 155 with the film-cooling holes 4 which issue into the cavity 30.

The masking material 22 is preferably present only in the film-cooling hole 4.

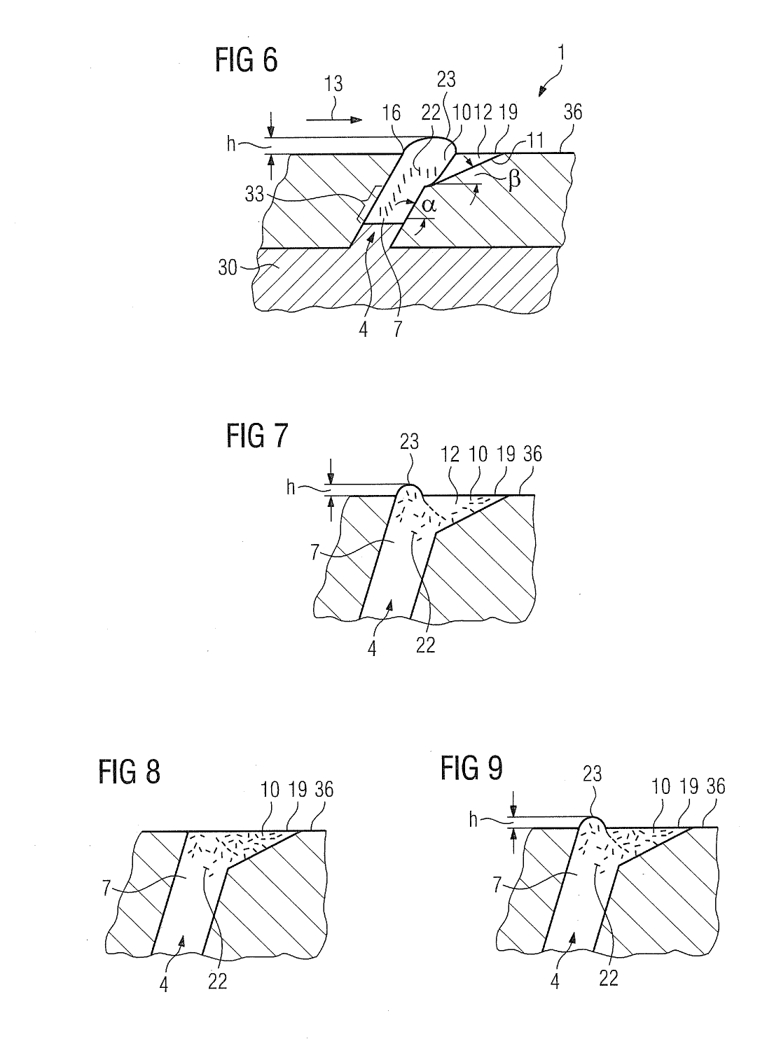

A free space 12 therefore remains in the film-cooling hole 4 at the end 19 underneath the imaginary continued plane of the outer surface 36, in which there is no masking 22. The masking 22 can also preferably protrude beyond the surface 36 above the cylindrical portion (FIG. 6), and then preferably has a height h, which corresponds to or is preferably higher than the coating to be applied.

FIG. 2 shows a plan view onto FIG. 1, in which the opening of the film-cooling hole 4 can be seen.

The overall length of the film-cooling hole 4 as seen in the direction of flow 13 is a+b.

A masking 22 is present over the length a, but no masking is present in the section b. The ratio of a:b is preferably 2:1.

FIG. 3 shows a further exemplary embodiment of a diffuser 10.

The diffuser 10 also widens transversely to the direction of flow 13. However, in this case, too, the polymer is present only partially, i.e. there is no polymer at the end 19 of the diffuser 10. The width of the region within the diffuser 10 where there is no polymer is the length b.

The polymer can likewise be applied only thinly over the length b, such that it is still present at the start of the coating process but is removed by erosion and/or the action of heat, and thus only then is a coating possible in the diffuser 10 (FIG. 4).

In this case, too, a free space 12 remains in the film-cooling hole 4 underneath the outer surface 36. Here, the masking 22 in the diffuser 10 does not extend as far as the surface 36. In this case, too, the masking material 22 can preferably protrude beyond the surface 36 of the substrate above the cylindrical portion 7 (FIG. 7).

If only a small amount of masking material 22 has been used in the diffuser (FIGS. 4, 7), this is removed by erosion and/or the action of heat during the coating, and, during the process for coating the component 1, the diffuser 10 is temporarily also coated, as a result of which the layer thickness is thinner in the diffuser 10 than on the surface 36.

It is likewise preferable that the diffuser 10 can also be filled completely with masking material 22 at least as far as the surface 36 (FIGS. 8, 9). Since the diffuser 10 extends in a shallow manner at the end 19, the masking material 22 erodes more quickly there during the coating as a result of thermal attack (molten material/vapor), and the diffuser 10 can be coated at the end 19. If appropriate, the polymer is cured to a lesser extent at the end 19 in order to achieve a higher material removal rate there.

FIG. 5 shows a film-cooling hole 4 after coating, which preferably had a polymer masking as shown in FIG. 1, 2, 3, 4, 6, 7, 8 or 9.

Since no or little masking was present at the end 19 of the diffuser 10, a part 28 of the coating 25 is deposited there during coating of the component 1, 120, 130, 155 with the film-cooling hole 4. This creates a smooth transition for the ascending gas station within the film-cooling hole 4 in the diffuser 10, and the air stream does not stop outside the film-cooling hole 4.

The coating 28 extends preferably only in the diffuser and very particularly only partially in the diffuser 10, i.e. at a considerable distance from the transition of the inner part 7. The layer thickness of the coating 28 preferably decreases in the direction of the inner portion 7.

FIG. 8 shows, by way of example, a partial longitudinal section through a gas turbine 100.

In the interior, the gas turbine 100 has a rotor 103 with a shaft 101 which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 foam the turbine 108.

Each turbine stage 112 is formed, for example, from two blade or vane rings. As seen in the direction of flow of a working medium 113, in the hot-gas passage 111 a row of guide vanes 115 is followed by a row 125 faulted from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-based, nickel-based or cobalt-based superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949.

The blades or vanes 120, 130 may likewise have coatings protecting against corrosion (MCrAlX; M is at least one element selected from the group consisting of iron (Fe), cobalt (Co), nickel (Ni), X is an active element and stands for yttrium (Y) and/or silicon, scandium (Sc) and/or at least one rare earth element, or hafnium). Alloys of this type are known from EP 0 486 489 B1, EP 0 786 017 B1, EP 0 412 397 B1 or EP 1 306 454 A1.

It is also possible for a thermal barrier coating to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 9 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11A1-0.4Y-2Re or Ni-25Co-17Cr-10Al-0.4Y-1.5Re.

It is also possible for a thermal barrier coating, which is preferably the outermost layer and consists for example of ZrO₂, Y₂O₃-ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

FIG. 10 shows a combustion chamber 110 of a gas turbine. The combustion chamber 110 is configured, for example, as what is known as an annular combustion chamber, in which a multiplicity of burners 107, which generate flames 156, arranged circumferentially around an axis of rotation 102 open out into a common combustion chamber space 154. For this purpose, the combustion chamber 110 overall is of annular configuration positioned around the axis of rotation 102.

To achieve a relatively high efficiency, the combustion chamber 110 is designed for a relatively high temperature of the working medium M of approximately 1000° C. to 1600° C. To allow a relatively long service life even with these operating parameters, which are unfavorable for the materials, the combustion chamber wall 153 is provided, on its side which faces the working medium M, with an inner lining formed from heat shield elements 155.

On the working medium side, each heat shield element 155 made from an alloy is equipped with a particularly heat-resistant protective layer (MCrAlX layer and/or ceramic coating) or is made from material that is able to withstand high temperatures (solid ceramic bricks).

These protective layers may be similar to the turbine blades or vanes, i.e. for example MCrAlX: M is at least one element selected from the group consisting of iron (Fe), cobalt (Co), nickel (Ni), X is an active element and stands for yttrium (Y) and/or silicon and/or at least one rare earth element or hafnium (Hf). Alloys of this type are known from EP 0 486 489 B1, EP 0 786 017 B1, EP 0 412 397 B1 or EP 1 306 454 A1.

It is also possible for a, for example, ceramic thermal barrier coating to be present on the MCrAlX, consisting for example of ZrO₂, Y₂O₃-ZrO₂, i.e. unstabilized, partially stabilized or fully stabilized by yttrium oxide and/or calcium oxide and/or magnesium oxide.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks.

Refurbishment means that after they have been used, protective layers may have to be removed from heat shield elements 155 (e.g. by sand-blasting). Then, the corrosion and/or oxidation layers and products are removed. If appropriate, cracks in the heat shield element 155 are also repaired. This is followed by recoating of the heat shield elements 155, after which the heat shield elements 155 can be reused.

Moreover, a cooling system may be provided for the heat shield elements 155 and/or their holding elements, on account of the high temperatures in the interior of the combustion chamber 110. The heat shield elements 155 are then, for example, hollow and may also have cooling holes (not shown) opening out into the combustion chamber space 154.

1.-11. (canceled)

12. A method for coating a substrate with a film-cooling hole, comprising:
providing the film-cooling hole including a diffuser with a start and an end as seen in a direction of flow;
introducing a masking at least partially into the film-cooling hole before the coating;
coating the substrate with the masking;
wherein there is no or little masking material in the diffuser at the end and there is masking material in a remaining region of the film-cooling hole, and
wherein the masking material is introduced into the film-cooling hole at the end of the diffuser, but not as far as a surface of the substrate or a further coating which is already present on the substrate outside the film-cooling hole.

13. The method as claimed in claim 12,
wherein as seen in the direction of flow, the diffuser has an extent of a first length plus a second length, and
wherein there is no masking material in the diffuser only in a region with the second length from the end of the diffuser.

14. The method as claimed in claim 12, wherein the masking extends over at least 60% of the extent in the diffuser.

15. The method as claimed in claim 12, wherein the masking material is arranged for the most part in an inner part of the film-cooling hole.

16. The method as claimed in claim 15, wherein the masking material is arranged in a cylindrical part of the film-cooling hole.

17. The method as claimed in claim 13, wherein a ratio of the first length to the second length is equal to 2:1.

18. The method as claimed in claim 12, wherein the masking material used is a polymer.

19. The method as claimed in claim 18, wherein the masking material further comprises an inorganic filling material.

20. The method as claimed in claim 12, wherein no masking is introduced at the end of the film-cooling hole.

21. The method as claimed in claim 12,
wherein the masking material protrudes beyond an outer surface of a component or beyond a further coating which is already present on the substrate outside the film-cooling hole.

22. A component, comprising:
a substrate; and
a film-cooling hole including a diffuser with a first end and a second end as seen in a direction of flow,
wherein a coating protrudes at least partially into the diffuser of the film-cooling hole and is disposed at most partially in the diffuser.

23. The component as claimed in claim 22, wherein there is no coating at the first end of the film-cooling hole.

24. The component as claimed in claim 22, wherein a further coating is arranged only in the diffuser.

25. The component as claimed in claim 24, wherein the further coating is arranged at most partially in the diffuser.

26. The component as claimed in claim 25, wherein a layer thickness of the coating in the diffuser decreases in a direction of an inner portion.

27. The component as claimed in claim 26, wherein the layer thickness of the coating in the diffuser decreases in the direction of a cylindrical portion.
